(19) United States
(12) Patent Application Publication
(10) Pub. No.: US 2012/0203806 A1
(43) Pub. Date: Aug. 9, 2012

(54) BUILDING INFORMATION MANAGEMENT SYSTEM

(76) Inventor: Ivan Panushev, New York, NY (US)

(21) Appl. No.: 13/022,555

(22) Filed: Feb. 7, 2011

(51) Int. Cl. G06F 17/30

(52) U.S. Cl. 707/825; 707/E17.005

(57) ABSTRACT

A building information management system integrates data from project management, facilities management and building design tools from a variety of sources, and stores this information for access in a central repository. Owners, builders, facilities managers, architects, engineers and contractors and other constituents can access, store, update and view the integrated data according to the tasks for which they are responsible. Files representing three-dimensional models are stored in the building information management system by parsing them into part files, and by creating mappings among the part files and metadata, and by storing the part files and mappings in a database. The part files and metadata are sufficiently smaller than the larger file representing the three-dimensional model and provide significantly improved viewing performance over a computer network.

### BACKGROUND

The information used in constructing and managing a building comes from a variety of sources and computer-based tools. Also, those sources and tools can change over time, resulting in the use of a variety of data formats. Managing and sharing this information among the various constituents involved with a building, such as owners, builders, facilities managers, architects, engineers and contractors, who also may change over time, is a challenging problem.

Current CAD/BIM (Computer Aided Design/Building Information Modeling) systems such as MicroStation products, which are developed by Bentley Systems, Inc. and AutoCAD and REVIT products, which are developed by Autodesk, Inc. use a single data file to encapsulate model data. The entire dataset is loaded into computer's physical memory in order for the user to see rendered three dimensional (3D) geometry and associated metadata for the requested building model.

A construction project generally uses numerous two dimensional (2D) and 3D CAD/BIM files which describe the project in some aspect. Local Area Networks (LAN) or web servers are typically used to exchange this data. In order for project participants to view and consume all the data, they have to download and store the individual files and open them on desktop machines, which have to load the files completely in order for the user to interact with them. A single CAD/BIM file can be from several kilobytes to hundreds of gigabytes; a project may have hundreds or thousands of such files. With increased use of CAD/BIM applications for design and authoring, the amount of data generated for each project therefore is very large. This amount of data cannot be exchanged with the current methods. Waiting for these files to download and loading them into the desktop memory is impractical.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A building information management system integrates data from project management, facilities management and building design tools from a variety of sources, and stores this information for access in a central repository. Owners, builders, facilities managers, architects, engineers and contractors and other constituents can access, store, update and view the integrated data according to the tasks for which they are responsible. Files representing three-dimensional models are stored in the building information management system by parsing them into part files, and by creating mappings among the part files and metadata, and by storing the part files and mappings in a database. The part files and metadata are sufficiently smaller than the larger file representing the three-dimensional model and provide significantly improved viewing performance over a computer network. Additionally, part files and metadata can be streamed individually to a user to create a composite 3D representation of a facility.

Such data streaming in a Building Information Management system involves transmitting portions of data for CAD/BIM models, each of which can be rendered independently, from a server to a viewer application. There are primarily two types of data: 2D/3D geometry data and metadata. This data is streamed by loading a first visible piece of the CAD/BIM dataset into the viewer application by loading first parts of the geometry. Then, in the background, both additional geometry and metadata are continually downloaded from the server to local memory for the viewer application, which can be implemented as a cache. After the user interacts with the initial view, the user may request either additional geometry or metadata. The system checks if the additional data have been already downloaded to the cache and loads them. If they do not exist in the cache, then they are requested from the server.

### DESCRIPTION OF THE DRAWINGS

FIG. 1 is block diagram of an example building information management system.

FIG. 2 is a data flow diagram describing example operation of the building information management system of FIG. 1.

FIG. 3 is a diagram of an example data structure for representing object data in a building information management system.

FIG. 4 is a diagram of an example system architecture.

FIG. 5 provides more details of part of FIG. 4.

FIG. 6 provides more details of part of FIG. 4.

FIG. 7 is a flowchart describing parsing of an object.

FIG. 8 is a flow diagram describing parsing of a 3D model.

FIG. 9 is a flow diagram describing parsing of project data.

FIG. 10 is a flow chart describing user navigation of a model.

FIG. 11 is a drawing of an example graphical user interface.

### DETAILED DESCRIPTION

In the following description, reference is made to the accompanying drawings, which form a part thereof and which show, by way of illustration, examples of how a building management system can be implemented. It is to be understood that other implementations can be made and used without departing from the scope of the claimed subject matter.

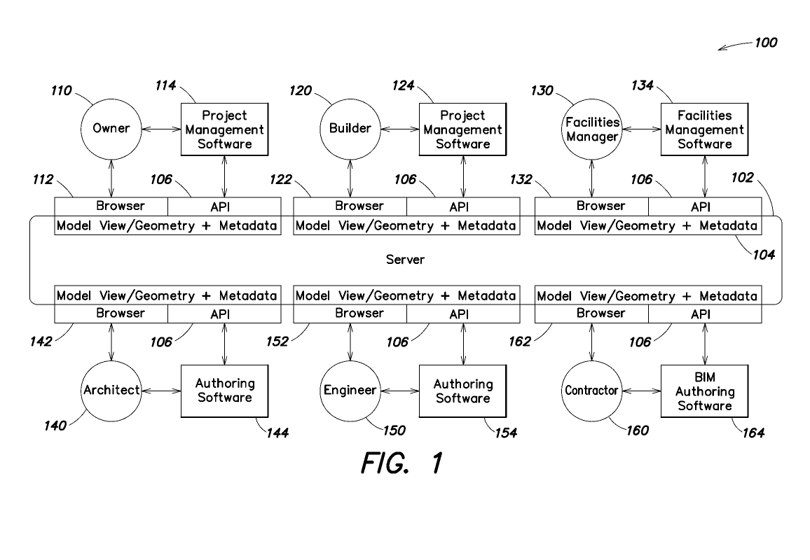

Referring to FIG. 1, an example building information management system 100 is shown. It includes a server 102 that is accessed by various constituents. For example, an owner 110 may access the server 102 through a browser 112 or project management software 114, such as Trimble's Proliance or Prolog. A builder 120 may access the server 102 through a browser 122 or project management software 124, Aconex's Project Collaboration. A facilities manager 130 may access the server 102 through a browser 132 or facilities management software 134, such as IBM's Maximo or Johnson Controls' Metasys. An architect 140 may access the server 102 through a browser 142 or authoring software 144, such as Autodesk's Revit or AutoCAD products. An engineer 150 may access the server 102 through a browser 152 or authoring software 154, such as Tekla's Structures. A contractor 160 may access the server 102 through a browser 162 or authoring software 164, such as MAP Software's CADduct or Trimble's QuickPen.

The server 102 stores the data from the various tools used by the various constituents in an integrated form in a database. This integrated form is called the model view, geometry and metadata 104. How this data is created, and its structure, are described in more detail below.

The model view, geometry and metadata 104 is structured to enable it to be accessed by a standard browser (e.g., 112 in FIG. 1) through a conversion of the data 104 to a web-based format, such as XML. An example format is described in more detail below. The browsers in FIG. 1 can be different types of browsers. Example browsers include, but are not limited to, Microsoft's Internet Explorer, Google Chrome, Apple Safari and Firefox browsers.

The various tools used by the constituents in FIG. 1 also can access the server 102 through an application programming interface (API) 106. The application programming interface provides a standard set of operations that can be performed on the server by all applications. Each application, such as a tool in FIG. 1, implements the application programming interface. Such an implementation is commonly achieved through a “plug-in” style architecture in the application, which is the application's own application programming interface. By authoring a plug-in to the application, which enables the application to interact with the server 102, this interface between tools and the server 102 through API 106 can be achieved.

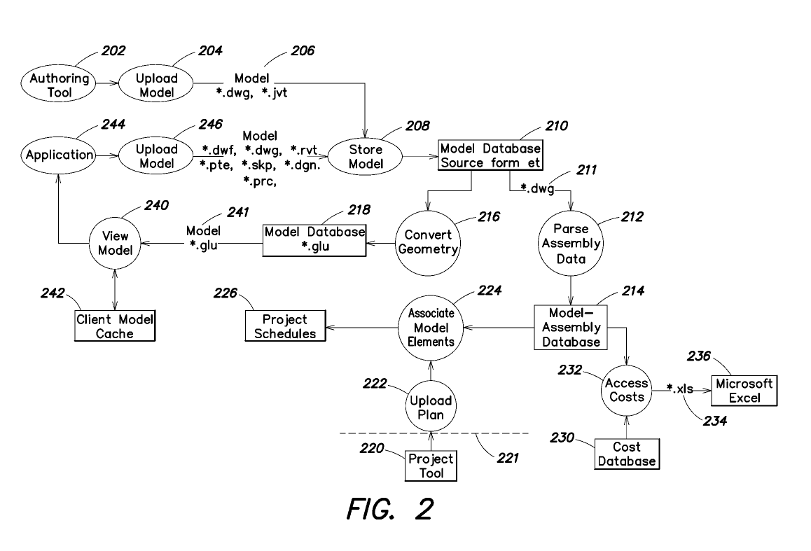

An example use case for this system will now be described in connection with FIG. 2. A user of an authoring tool 202, such as the AUTOCAD or REVIT computer assisted design software from Autodesk, Inc., uploads 204 a model 206 to the server. The server stores 208 the model in a model data repository 210 in source form. The server initiates a parsing process 212 using a model 211, to generate model assembly data that is placed in a model assembly database 214. This is the metadata that can be stored, for example, in XML files as described in more detail below. A database can be used to map models in the repository 210 with the model assembly data (metadata) in such XML files. Also, the server initiates a conversion process 216 to convert geometry data of the model to a generic form, described in more detail below, used by a model database 218. As a result, the database includes the model data source in model data repository 210, the model assembly data in database 214 and the generic model data in database 218.

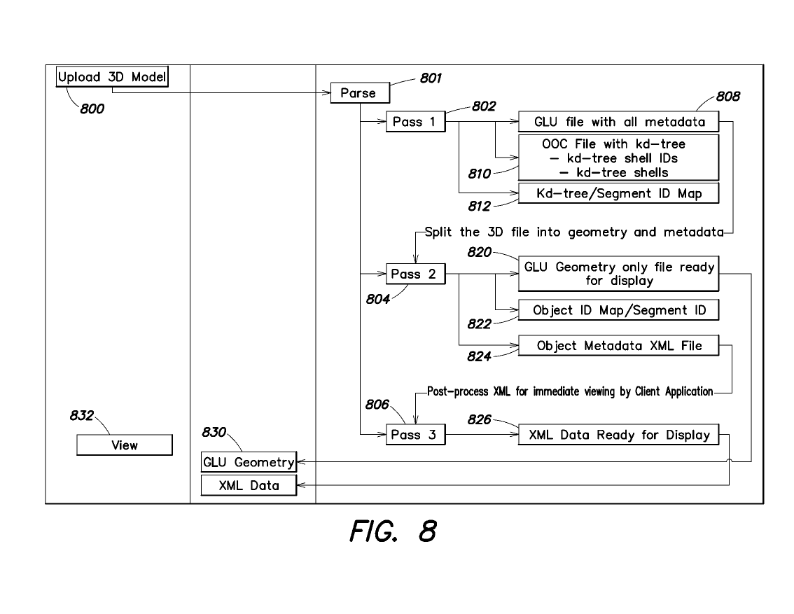

The model data source is the original files from the authoring tools. The model assembly data and generic model data are, respectively, metadata and part files that provide a representation of the model. This representation allows model data to be streamed and to be integrated with the project management and other data. This representation provides the model view, geometry and metadata 104 of FIG. 1. The objects in the source models in the model data repository 210 are mapped to the objects in the generic model data in database 218 by globally unique identifiers (GUIDs) which are unique for each logical object, such as wall, door, door handle, etc. These identifiers can be assigned during a parsing process such as described below in connection with FIG. 8. After the model data is broken into part files, the GUIDs for each part are stored in the model assembly data. In particular, XML files that store the metadata also contain explicit references to the GUIDs, as shown in Appendix A and described in more detail below.

With the model information in the databases, several other actions can be performed.

For example, using a project management tool 220, such as the PROJECT software from Microsoft Corporation, a project plan 221 can be uploaded 222. Given an uploaded plan, elements of the plan can be associated 224 with model elements in the database, to create project schedules 226 associated with the model data.

As another example, costing information from a database, such as RS Mean by Reed Construction Data 230, can be accessed 232 along with model data to which it is associated. This information can be provided in spreadsheets 234 to a spreadsheet tool 236, such as the EXCEL spreadsheet software from Microsoft Corporation.

As another example, a user may decide to view 240 model data, which can be accessed from either a cache 242 at the client or from the database 218 as indicated at 241. This data is provided to the viewer component 244 of the Building Information Management System. In some implementations, the viewer component 244 can allow the end user the modify the model or data associated with it, which in turn can be uploaded 246 to the database.

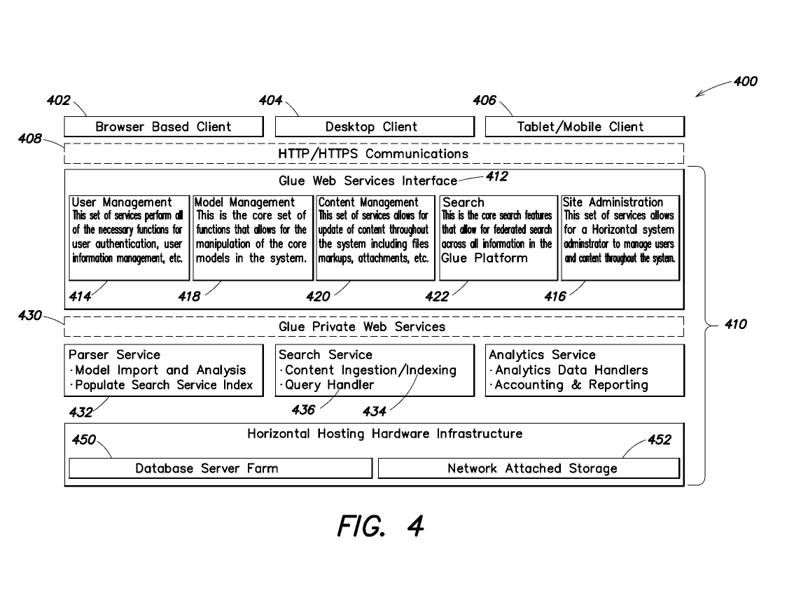

FIGS. 4 through 6 provide more detail of an example implementation of such a system. Referring to FIG. 4, the client applications 400, whether a browser based client 402, a desktop client 404 or a mobile or tablet based client 406, communicate with the server 410 over an HTTP or HTTPS communication link 408. The server 410 is executing applications called web services 412 which are accessed by client applications using such a communication link.

The web services 412 can include user management services 414, which perform functions for user authentication and user information management. Site administration services 416 can be provided to allow a system administrator to manage users and content throughout the system. Model management services 418 are for manipulating models in the system. Content management services 420 are for updating content in the system, such as files, markups, attachments and the like. Search services 422 allow for federated search across all information in the system.

Private web services 430 are not directly accessed by the client applications 400 but instead are used by the other web services. For example, model management services 418 access a parser service 432 for model input and analysis and for populating an index used by the search service. The search services 422 access specific search services such as content ingestion and indexing services 434 and query handling services 436. An analytics service 436 is available to provide data handlers for performing analytics and for accounting and reporting.

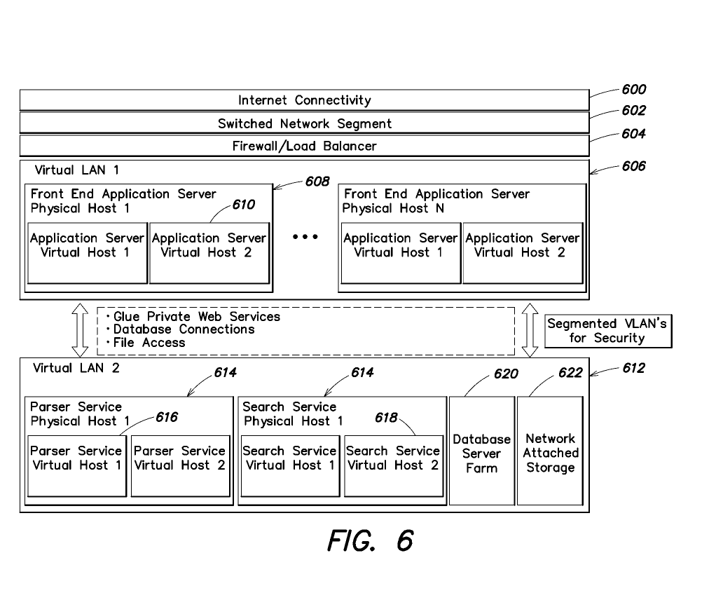

These services are hosted on a database server farm 450 with network attached storage 452 and accessed over a network, shown in more detail below in connection with FIG. 6

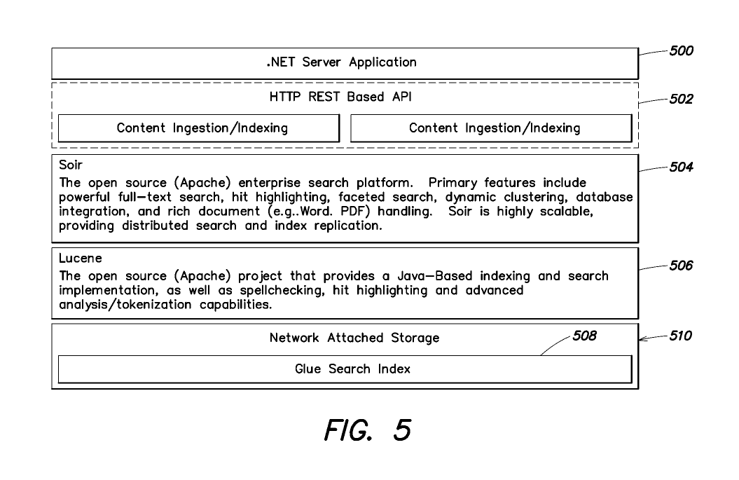

Referring now to FIG. 5, more details about an example implementation of the web services will now be described. The web services can be implemented as .NET Server applications 500. This application accesses content ingestion and indexing services through an HTTP based API 502, implemented in the Representational State Transfer (REST) style. The SOIR enterprise search platform 504 can be used for providing full-text search, hit highlighting, faceted search, hynamic clustering, database integration and rich document handling. The Lucene indexing and search application 506 can be used for spellchecking, hit highlighting and advanced analysis/tokenization capabilities. The search index 508 generated using such a tool would reside on the network attached storage 510.

Referring now the FIG. 6, an example implementation of such a system will be described in more detail. In particular, the internet connectivity 600 through which client applications access the system is connected to a switched network segment 602, which directs communication traffic through a firewall and load balancer 604 to a virtual local area network (virtual LAN) 606. The virtual LAN includes one or more physical host machines 608, each of which runs one or more virtual host servers 610 which provide the web services applications. These web services access a second virtual LAN 612 which includes one or more physical host machines 614 running the private web services such as the parser service 616 and the search service 618. The virtual LAN 2 also provides connections to the database server farm 620 and network attached storage 622.

Having now provided an overview of an example building information system and some example use cases, an example structure for the building information as stored in the database will now be described in more detail.

In this building information system, the basic building block of the integrated data is an “object.” An object typically corresponds to a physical object such as part of a building or an abstract object such as an amount of money. An object is a construct in memory that stores data representing its corresponding physical or abstract object and its relationships with other objects.

With three-dimensional or two-dimensional model data, an object represents a part of the model. The model data from, for example, an authoring application is parsed to identify various models, or parts of models, of physical objects, data about them, and their interrelationships. When an object is created, it includes data that represents geometry segments and metadata. The geometry segments are defined by geometry data, attributes and subsegments, if any. A subsegment, in turn, is a segment and thus is defined by geometry data, attributes, and subsegments, if any. Such three dimensional models can be represented by a quad tree, such as a kd-tree, for example.

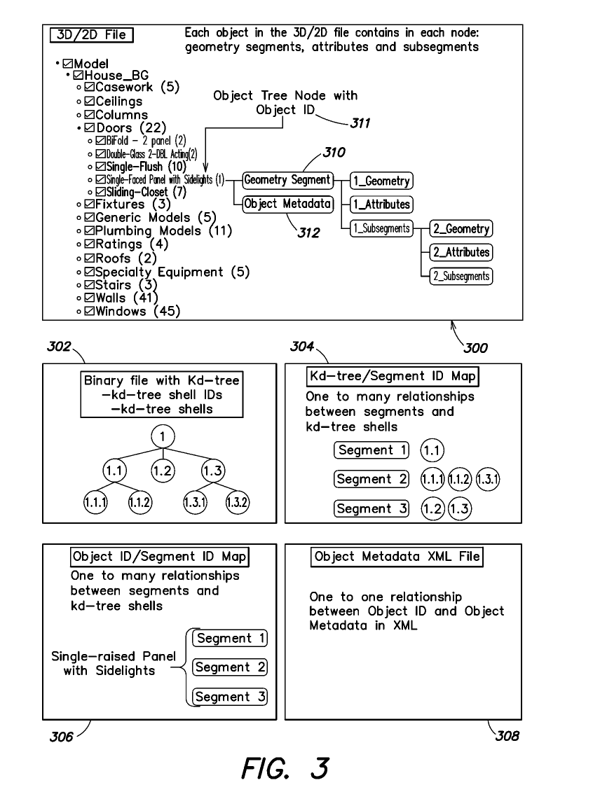

Referring now to FIG. 3, example data structures for representing objects will now be described. When a model 300 of a building is parsed (e.g., at 212 in FIG. 2), the following information is created: a binary file 302 representing a kd tree including nodes (herein called shells) with shell identifiers, a map 304 of segment identifiers to kd tree shell identifiers stored in the binary file 302, a map 306 of object identifiers to segment identifiers and an object metadata file 308 that includes the map 306.

Each object in the model 300 has a globally unique identifier (GUID) 311, geometry 310 and metadata 312. The metadata 312 is placed in the object metadata file 308. The metadata includes, for example, names for the different objects in the model, and names of their parts. For example, a three dimensional model could be represented by a semantic tree that labeled all of its primary parts, and their constituent parts. A simple model of two walls, one with a door, would be represented by a root node (the model), which had two child nodes (wall 1 and wall 2), of which one of these would include a door (door 1). Information about each one of these components could be stored in an XML file. Example XML files for such a two wall model are shown in Appendix A and Appendix B. Such a file can include, for each object, its GUID (“obj-id” in the Appendices) and its segment identifier (“id” in the Appendices). Each object in an XML file also can have its own identifier within the file (e.g., “<i10> . . . </i10>”) which can be used by other XML files to cross-reference elements between files (e.g., “Index=‘10’”). For example, the XML file in Appendix B includes references to elements in the XML file in Appendix A.

The geometry 310 of the object is represented by its segments in three-dimensional space, attributes and subsegments. The segments are associated with the nodes of the kd tree which contain them. Each segment also has an identifier. There is a one-to-many relationship between a segment identifier and kd-tree shells. There is a one-to-many relationship between an object identifier and segments. There is a one-to-one relationship between an object identifier and its corresponding object metadata files. The representation of a model using a kd tree and segment data can be implemented using a framework called the HOOPS 3D Application Framework, available from Tech Soft 3D. The kd-trees and segment data created using this application framework can be combined with the segment identifier and kd-shell identifier mappings and stored in a binary file called a part file.

In this example, the kd-tree is a data structure that represents the three dimensional space in which the model of the building resides. Each node in the kd tree represents a portion of the three dimensional space. Generally speaking, however, a kd-tree is a form of quad tree and is a data structure well known in the field of computer science as particularly useful in dealing with orthogonal range queries. See The Art of Computer Programming, by Donald E. Knuth, Vol. 3, Second Edition (Reading, Mass.: Addison Wesley Longman 1998), pages 565-566. Herein, each node in the kd tree is called a shell, and has a shell identifier. Each node is also associated with segments from the three dimensional model that are contained within the portion of the three dimensional space represented by the node.

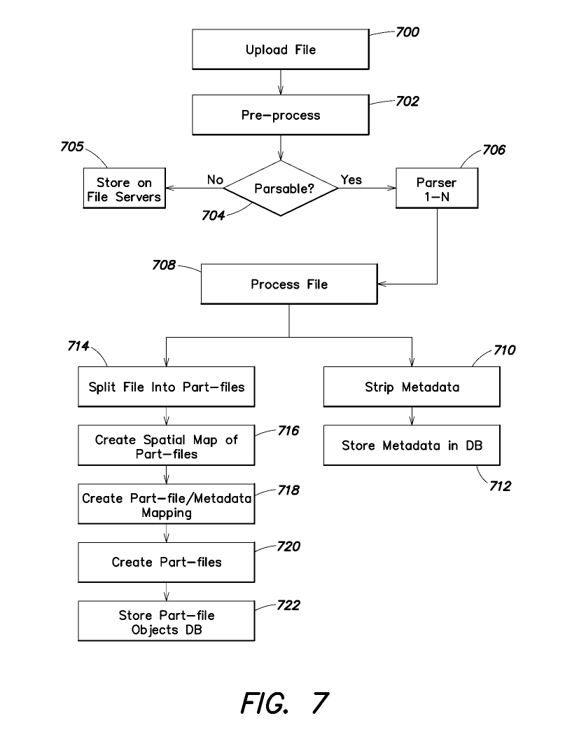

A parser generates these data structures from a model when the model is uploaded to the system. As an example, referring now to FIG. 7, a file is uploaded 700, and the file is pre-processed 702 to determine the type of file and parser to be used. If the file is not parseable (e.g., a parser is not available for the file type), as determined at 704, then the file is stored 705 in the file server. Otherwise, the appropriate parser is selected (706). In general, a parser processes 708 the file, separating model information from metadata. The metadata is stripped 710 from the file and stored 712 in the metadata XML with metadata to geometry mapping stored in a database. With the model data, the rest of the file is split 714 into part files. A spatial map of the part files is then created 716. A mapping is then created 718 between the part files and metadata. The part files are then created 720. These different objects are then stored 722 in the data repository, with the mappings between part files and metadata and the spatial map of the part files being stored in a database. This database can store this data in a manner that is indexed by a project identifier and record identifier to enable them to be retrieved easily.

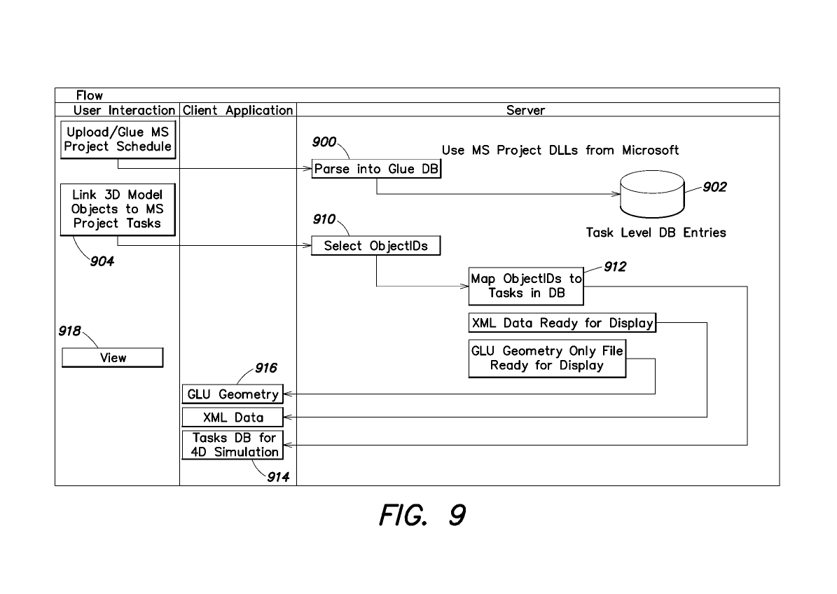

More details about parsing will now be described in connection with FIGS. 8 and 9. A three dimensional model is uploaded (see 800 in FIG. 8) by the user through the client application, which in turn invokes 801 the parsing service of the web services on the server. The parser has three passes, as shown at 802, 804 and 806. In the first pass, the 3D model file with all metadata is created (808) as a single file. An OOC file with the kd-tree, kd-tree shell identifiers and kd-tree shells is created (810), using the HOOPS framework. The kd-tree and segment identifier mapping is also created (812).

In the second pass, the 3D file created at 808 is processed 820 to create a geometry-only file ready for display. The mappings between the object identifiers and segment identifiers is created 822. An object metadata XML file is created 824. This Object metadata file is the input to the third pass of the parser, which manipulates 826 the XML data to be ready for display. The geometry data created at 820 and the XML data created at 826 are stored on the server and are used by viewing component as shown at 830, to be viewed 832 by the user.

Referring to FIG. 9, a parser also can process other types of files, such as project management files (e.g., from Microsoft's PROJECT software). In this implementation, tools available from Microsoft can be used to process a PROJECT file to extract tasks and create level database entries, as indicated at 900 and 902. A user can link 904 objects in a three dimensional model with project tasks. With this information passed by the client application to the server, the server can select 910 object identifiers, and map 912 object identifiers to tasks in the database. The tasks database can then be used in the viewing component at the client application for 4D simulation 914, with the geometry and metadata as shown at 916, for viewing 918 by the user.

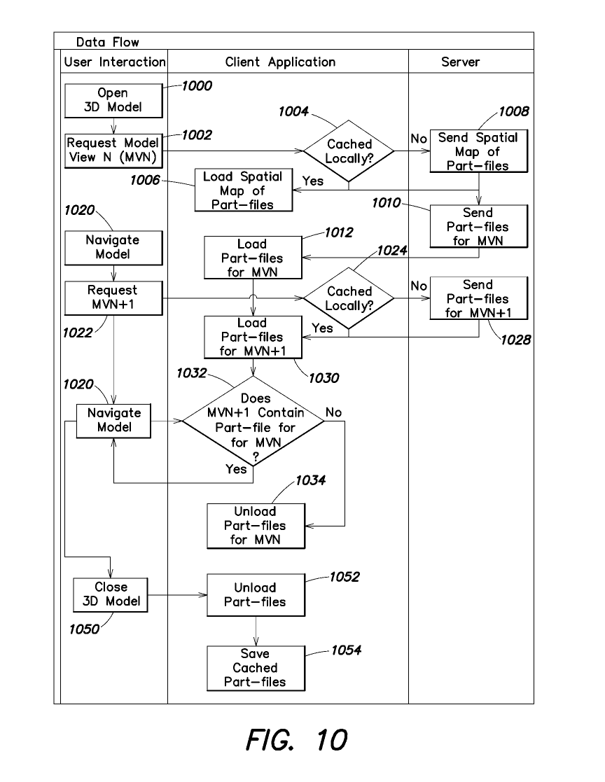

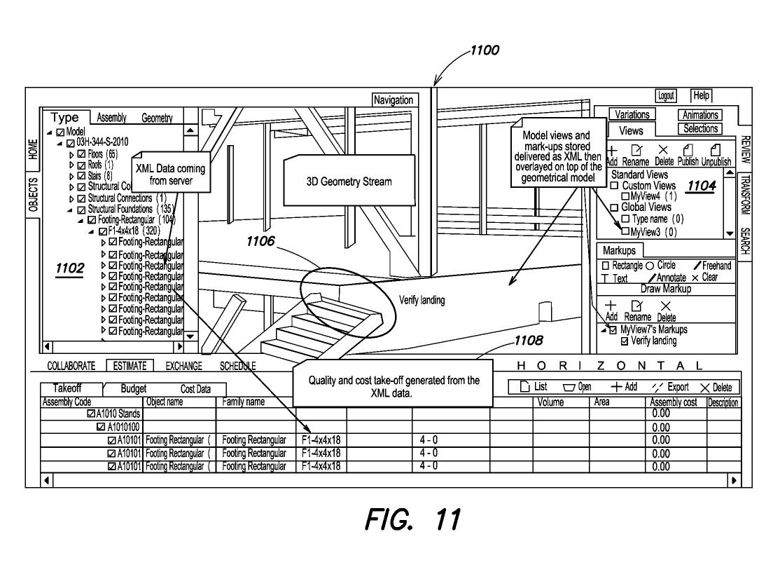

Given a database with such representations of models, metadata and other information, the user interaction with it will now be described in connection with FIGS. 10-12.

In FIG. 10, an example of typical use will now be described. A user will select and open 1000 a three dimensional (3D) model, and request 1002 a model view N (MVN). The client application determines if that model view is cached locally (1004). If the model view is cached locally, then the spatial map of part-files is loaded (1006). If the model view is not cached locally, then the server sends (1008) the spatial map of the part files for this model view. The server then sends (1010) the part files for this model view. The client application loads (1012) the received part files for this model view. After, the part files for the geometry are loaded the XML metadata file starts downloading in the background.

At this point, the user can navigate (1020) through the model, which might result in a request 1022 for, and a need to access the data for, the model view N+1. The client application determines if that model view is cached locally (1024). If the model view is cached locally, then the spatial map of part-files is loaded (1026). If the model view is not cached locally, then the server sends (1028) the part files for this model view. The client application loads (1030) the received part files for this model view.

The application also checks 1032 if the part files for the model view N+1 contain the part files for model view N. If no, then the part files for model view N can be unloaded 1034, freeing up memory space and speeding up rendering of the model. If the user stops navigating the model, and instructs the client application to close (1050) the model, then the part files are unloaded 1052 by the client application. The cached spatial map of the part files and other cached files can be saved 1054 by the client application.

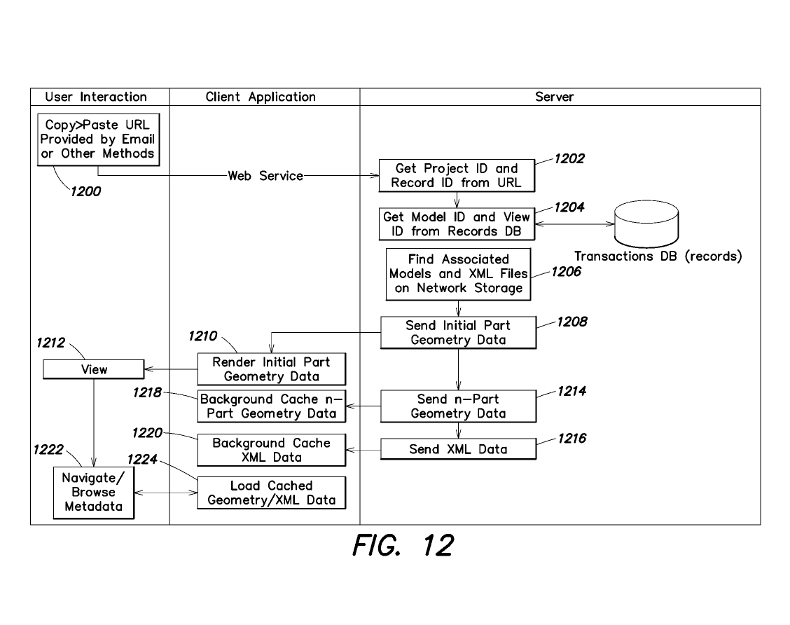

Referring to FIG. 11, a graphical user interface for a client application that navigates models will now be described. As with most graphical user interfaces, a display is used to display various data and controls that allow a user to initiate commands or otherwise manipulate the display. The user could control the interface with a keyboard, pointing device or touchscreen controls.

The center of the display is a rendering 1100 of the currently selected model view. On the left of the display is a control panel 1102 that allows a user to select a part of a model. XML data from the server describes the object hierarchy using the metadata describing the 3D model. When a user selects a model to be viewed, the XML file corresponding to the model file is accessed to obtain the object hierarchy. This navigational aid allows the user to select a model view. Either the data from a files such as shown in Appendix A could be used (to provide the “Type Tree” display), or the data from a file such as shown in Appendix B could be used (to provide the “Assembly” display. On the right of the display, another control panel 1104 allows a user to specify different views, and add markups to a model (such as shown at 1106). At the bottom 1108 of the display, various information about a project could be shown, such as cost information for the different pieces of the model.

FIG. 12 describes an implementation where the user requests a model by using a uniform resource locator (URL) related to web services that access the data repository. A user provides the URL (indicated at 1200) for a web service to a client application, which submits the URL to the corresponding server over a network. The URL includes a project identifier and a record identifier. The server extracts 1202 the project identifier and record identifier from the URL, and retrieves 1204 a model identifier (to retrieve a part file) and a view identifier (to retrieve a metadata file) from the database. These identifiers are used to retrieve 1206 the model files and the metadata files from the data repository. The data streaming process is initiated by sending 1208 an initial geometry file to the client application. The client application renders 1210 the initial geometry file, which can be viewed 1212 by the user. In the background, the server can send 1214 the n-part geometry files and the XML file (1216), both of which are cached (1218, 1220) by the client application. As the user navigates and browses 1222 through the data using the client application, the client application may load 1224 additional from the cache as needed.

Because the files representing three-dimensional models are stored in the building information management system by parsing them into part files, and by creating mappings among the part files and metadata, the part files and metadata are sufficiently smaller than the larger file representing the three-dimensional model. In this interface, only the selected portion of the model is loaded in the client application and rendered, providing significantly improved viewing performance over a computer network.

The techniques described above can be implemented in digital electronic circuitry, or in computer hardware, firmware, software executing on a computer, or in combinations of them. The techniques can be implemented as a computer program product, i.e., a computer program tangibly embodied in tangible, machine-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment.

A computer program can be deployed to be executed on one computer or on multiple computers at one site or distributed across multiple sites and interconnected by a communication network. Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system can include clients and servers. A client and server are generally remote from each other and typically interact over a communication network. The relationship of client and server arises by virtue of computer programs running on the respective computers and having a client-server relationship to each other.

Having described example implementations, it should be apparent to those skilled in the art that the foregoing is merely illustrative and not limiting, having been presented by way of example only. It should be understood that the subject matter defined by the appended claims is not limited to such examples.

APPENDIX A

| | |
|---|---|
| | <?xml version=“1.0” encoding=“Windows-1252” ?> |
| − | <Glu> |
| − | <Model Name=“2walls” File_ID=“af6a91a7-9e52-4166-a81e-eba0d7c1d3da” |
| | Extension=“.dwf”> |
| − | <i-1> |
| − | <i28> |
| − | <i27 |
| | Properties=“units_type=ft,modeling_matrix=1.000000#0.000000#0.000000#0.0000 |
| | 00#0.000000#1.000000#0.000000#0.000000#0.000000#0.000000#1.000000#0.000000# |
| | 0.000000#0.000000#0.000000#1.000000”> |
| − | <i26 Name=“Walls (2)” Properties=“node,object_id=u6AsPsj_VkWqjnEPjhedKA”> |
| − | <i25 Name=“Basic Wall (2)” |
| | Properties=“node,object_id=vqAsPsj_VkWqjnEPjhedKA”> |
| − | <i24 Name=“Generic - 8 (2)” |
| | Properties=“node,object_id=waAsPsj_VkWqjnEPjhedKA,width=0 - 8 category = |
| | Construction,assembly code=B2010 category = Identity Data,type name=Generic |
| | - 8 category = Identity Data,family name=Basic Wall category = Other”> |
| − | <i23 Name=“Basic Wall [138062]” |
| | Properties=“node,object_id=xKAsPsj_VkWqjnEPjhedKA,id=474b83ea-9104-4598- |
| | 9ee4-46ed0a0b6c07,base constraint=Level 1 category = Constraints,base |
| | offset=0 - 0 category = Constraints,room bounding=Yes category = |
| | Constraints,top offset=0 - 0 category = Constraints,unconnected height=20 - |
| | 0 category = Constraints,structural usage=Non-bearing category = |
| | Construction,area=139 SF category = Dimensions,length=7 - 8 category = |
| | Dimensions,volume=92.67 CF category = Dimensions”> |
| − | <i22> |
| | <i20 Properties=“edges” /> |
| | </i22> |
| | </i23> |
| − | <i18 Name=“Basic Wall [138146]” |
| | Properties=“node,object_id=x6AsPsj_VkWqjnEPjhedKA,id=474b83ea-9104-4598- |
| | 9ee4-46ed0a0b6ceb,base constraint=Level 1 category = Constraints,base |
| | offset=0 - 0 category = Constraints,room bounding=Yes category = |
| | Constraints,top offset=0 - 0 category = Constraints,unconnected height=20 - |
| | 0 category = Constraints,structural usage=Non-bearing category = |
| | Construction,area=129 SF category = Dimensions,length=6 - 9 category = |
| | Dimensions,volume=85.55 CF category = Dimensions”> |
| − | <i17> |
| | <i15 Properties=“edges” /> |
| | </i17> |
| | </i18> |
| | </i24> |
| | </i25> |
| | </i26> |
| − | <i13 Name=“Doors (1)” Properties=“node,object_id=sKAsPsj_VkWqjnEPjhedKA”> |
| − | <i12 Name=“Single-Flush (1)” |
| | Properties=“node,object_id=s6AsPsj_VkWqjnEPjhedKA”> |
| − | <i11 Name=“36 × 84 (1)” |
| | Properties=“node,object_id=tqAsPsj_VkWqjnEPjhedKA,height=7 - 0 category = |
| | Dimensions,thickness=0 - 2 category = Dimensions,width=3 - 0 category = |
| | Dimensions,assembly code=C1020 category = Identity Data, type name=36 × 84 |
| | category = Identity Data,family name=Single-Flush category = Other”> |
| − | <i10 Name=“Single-Flush [138218]” |
| | Properties=“node,object_id=uKAsPsj_VkWqjnEPjhedKA,id=474b83ea-9104-4598- |
| | 9ee4-46ed0a0b6ca3,1evel=Level 1 category = Constraints,sill height=0 - 0 |
| | category = Constraints,mark=1 category = Identity Data,head height=7 - 0 |
| | category = Other,host id=Basic Wall [138062] category = Other”> |
| − | <i9 Properties=“node”> |
| − | <i8> |
| | <i6 Properties=“edges” /> |
| | </i8> |
| − | <i4> |
| | <i2 Properties=“edges” /> |
| | </i4> |
| | </i9> |
| | </i10> |
| | </i11> |
| | </i12> |
| | </i13> |
| | </i27> |
| | </i28> |
| | </i-1> |
| | </Model> |
| | </Glu> |

APPENDIX B

| | |
|---|---|
| | <xml version=“1.0” encoding=“utf-8” ?> |
| − | <Assemblies> |
| | <Assembly Index=“23” Name=“Basic Wall [138062]” MeasureUnit=″″ |
| | AssemblyCost=″″ Type=″″ AssemblyCode=“B2010” TypeName=“Generic - 8” |
| | FamilyName=“Basic Wall” Area=“139 SF” Length=“7 - 8” Volume=“92.67 CF” /> |
| | <Assembly Index=“18” Name=“Basic Wall [138146]” MeasureUnit=″″ |
| | AssemblyCost=″″ Type=″″ AssemblyCode=“B2010” TypeName=“Generic - 8” |
| | FamilyName=“Basic Wall” Area=“129 SF” Length=“6 - 9” Volume=“85.55 CF” /> |
| | <Assembly Index=“10” Name=“Single-Flush [138218]” MeasureUnit=″″ |
| | AssemblyCost=″″ Type=″″ Height=“7 - 0” AssemblyCode=“C1020” TypeName=“36 × |
| | 84” FamilyName=“Single-Flush” /> |
| | </Assemblies> |

What is claimed is:

1. A computer-implemented process for importing building information into a building information management system, comprising:
parsing, using a computer processor, the building information into part files;
identifying metadata associated with the part files;
creating a mapping among the part files and the metadata associated with the part files; and
storing the mapping, metadata and part files on a computer storage device.

2. The computer implemented process of claim 1, wherein the mapping comprises:
a kd-tree having a node for each segment of the part files;
a one-to-many mapping of segment identifiers to nodes in the kd-tree;
a one-to-many mapping of object identifiers to segment identifiers; and
a file describing metadata for each object.

3. A computer implemented process for allowing a user to navigate building information, comprising:
accessing in memory a mapping of metadata and part files describing an object hierarchy of a three dimensional model of a building;
allowing a user to select, through a user interface, an object in the object hierarchy;
accessing a part file including three dimensional data representing the object;
rendering the object;
allowing the user to navigate the three dimensional model;
when the user selects a different object in the object hierarchy then accessing a part file including three dimensional data representing the different object and rendering the different object.

4. The computer implemented process of claim 3, wherein the mapping comprises:
a kd-tree having a node for each segment of the part files;
a one-to-many mapping of segment identifiers to nodes in the kd-tree;
a one-to-many mapping of object identifiers to segment identifiers; and
a file describing metadata for each object.

5. A computer-implemented method for streaming building information, comprising:
receiving a first part file and related metadata for a part of a three dimensional model of the building;
rendering and displaying the received part file;
receiving and caching additional part files and metadata representing parts of the model adjacent to the part of the model represented by the first part file;
receiving information from the user about navigation in the three dimensional model; and
repeating the steps of rendering and receiving and caching part files and metadata in accordance with the user navigation.
